(19) United States
(12) Patent Application Publication
(10) Pub. No.: US 2023/0405536 A1
(43) Pub. Date: Dec. 21, 2023

(54) INLINE STATIC MIXER

(71) Applicant: Lummus Technology LLC, Bloomfield, NJ (US)

(72) Inventors: Baozhong Zhao, Bloomfield, NJ (US); Xueping Li, Bloomfield, NJ (US); Kishan Thakurdin, Bloomfield, NJ (US); Alejandro Carrillo, Bloomfield, NJ (US); Richard Jibb, Bloomfield, NJ (US)

(21) Appl. No.: 18/332,965

(22) Filed: Jun. 12, 2023

Related U.S. Application Data
(60) Provisional application No. 63/351,755, filed on Jun. 13, 2022.

(51) Int. Cl. B01F 25/435; B01F 25/431; B01F 25/4314; B01F 23/232; B01F 35/91

(52) U.S. Cl. CPC B01F 25/435; B01F 25/431971; B01F 25/4314; B01F 2025/913; B01F 35/91; B01F 2215/0422; B01F 23/232

(57) ABSTRACT

An inline static mixer includes an outer tube and an inner tube positioned inside the outer tube and arranged coaxially with respect to the outer tube with a space between the inner and outer tubes. The inner tube is operable to receive and convey a hydrocarbon stream and the outer tube is operable to receive and convey a diluent stream. At least one baffle extends from the inner tube toward the outer tube and through at least a portion of the space that is operable to generate a twisted diluent flow from the diluent stream. The twisted diluent flow and the hydrocarbon stream are mixed downstream of an outlet of the inner tube with the twisted diluent flow forming a boundary layer along an internal surface of the outer tube to minimize fouling from liquid or liquid droplets of the hydrocarbon stream after mixing.

### BACKGROUND

### Technical Field

The present disclosure is generally directed to a static mixer and more particularly, but not exclusively, to an inline static mixer with a flow twister for mixing fluid streams.

### Description of the Related Art

Static mixers are known for use with petrochemical processing, and in particular for the production of ethylene and/or propylene. Traditional static mixers mix two fluid streams, such as a gaseous diluent stream and a feedstock stream that is liquid, partially liquid and partially vapor, or contains liquid droplets. The combined feedstock-diluent mixture is then provided to a heater to create a heated feedstock-diluent mixture for further processing.

Prior mixer designs mix the streams at the mechanical parts, or right after the mechanical parts. More specifically, such designs mix the diluent and hydrocarbon feedstock by direct contact within the mixing device, and prior to indirectly heating the mixture in the tubes of a convection section. In practice, the liquid or liquid droplets will not instantly vaporize, but will require some distance to reach a thermal equilibrium such that liquid will inevitably contact the heated wall of the convection section tubes and leave fouling deposits. In other words, if there are any liquid droplets, the droplets will impinge with the mechanical parts or contact surfaces of the mechanical parts downstream of the mixer, which can cause fouling over time. Such deposits must routinely be cleaned and removed, which increases operational costs, decreases yield over time, and increases maintenance downtime. Alternatively, such deposits may restrict flow and decrease heater throughput, which decreases yields. In addition, some static mixers cause a high pressure drop, which can decrease yields or otherwise increase compressor operational costs to modify the pressure for desirable yields. Certain solutions have been proposed in response, but such solutions have various deficiencies and drawbacks.

For example, one solution is a device that promotes mixing at different stages along the fluid flow to help provide a more uniform mixing of single phase flow. In such an example, the distribution of concentration or distribution of temperature of the fluid in the direction of flow is constant. However, fouling deposits can still occur at the various mixing stages and separate stages may also lead to a high pressure drop.

An alternative solution promotes mixing of two streams or a single stream by creating a more turbulent flow through the device and varying the flow area along the flow path. However, this solution likewise produces a high pressure drop. Additional solutions includes a co-axial static mixer in which the two streams are contacted inside the device, but such solution is likewise prone to leaving fouling deposits. In some variations, co-axial static mixers create two opposite rotational flows that lead to more mixing into each other, but applicability may be limited to streams that have no potential of fouling.

Yet further mixers promote mixing of a single stream. Such mixers contain a spoiler that exerts a force on the fluid flow from an external source to create wavelike mixing. Such solution increase the overall complexity of the mixer and may produce a high pressure drop. In some variations, the single stream fluid flow is instead split into different sections. The flow area changes in each section in the direction of flow, which changes the flow velocity, with some sections being higher and lower. The streams from the various sections meet and inter-mix, but fouling may occur at such inter-mixing location.

Some prior static mixers have a stack of mixing elements or similar structures. Adjacent elements will direct the flow in opposite directions as the fluid flows through the element. While this solution can reduce fouling for single streams, it is prone to a high pressure drop associated with changes in direction of the fluid.

It would therefore be desirable to have a static mixer that overcomes the deficiencies and disadvantages of known static mixers.

### BRIEF SUMMARY

The present disclosure is generally directed to inline static mixing devices, systems, and methods for hydrocarbon processing applications. In particular, the mixers of the present disclosure may include a flow twisting device provided in a form factor of helical vanes in either or both of the tubes for creating a swirling flow in the mixer that forms a boundary layer along mechanical components that is high in dilution steam and low in hydrocarbon. Such an arrangement advantageously mixes the streams without a significant pressure drop while also minimizing contact between the hydrocarbon and mechanical components to reduce fouling or impurity deposits. In particular, the concepts of the disclosure minimize any potential hydrocarbon fouling or any impurity deposit to the internal surface of the heating coil.

In one or more embodiments, a method is provided for introducing a liquid or partially liquid hydrocarbon feedstock along with a diluent into a cracking heater to create a superheated feedstock-diluent mixture. The diluent stream and the hydrocarbon stream are introduced coaxially to a convection section with the vapor diluent on the outside and the liquid or partially liquid hydrocarbon stream on the inside. A swirl flow may be imparted to either the hydrocarbon or diluent flow, or both. The cracking heater has a heating surface in the convection section that preheats the hydrocarbon feed stock. Dilution steam is applied to the hydrocarbon to desirably promote hydrocarbon vaporization for the liquid feed to the heater and reduce the hydrocarbon partial pressure in the stream for optimum yields, such as ethylene and/or propylene yields.

In one or more embodiments, a mixing device includes an inline flow twisting device. The mixing device is installed in line with the hydrocarbon stream and includes a branch connection for the dilution steam to be mixed with the hydrocarbon. Before the steam mixes with the hydrocarbon, the device creates a swirling flow near the heating coil internal surface and forms a boundary layer that is high in dilution steam and low in hydrocarbon. The boundary layer delays, prevents, or minimizes the hydrocarbon droplets from contacting the heater coil internal surface prior to full vaporization of the hydrocarbon. At the same time, the twisting dilution steam flow will promote desired flow mixing between the hydrocarbon and dilution steam. It is preferred to fully vaporize the liquid droplets before the droplets enter the heat receiving surface section to reduce fouling and impurity deposits. In one or more embodiments of the device, any residual hydrocarbon droplets will be separated by the dilution steam boundary layer and become fully vaporized before reaching the heat receiving surface section. As a result, the device minimizes the risk of surface fouling by the heavy hydrocarbon components or impurities.

### BRIEF DESCRIPTION OF THE SEVERAL VIEWS OF THE DRAWINGS

FIGS. 1A-1C are schematic diagrams of a known static mixer.

FIG. 2 and FIG. 3 are schematic diagrams of an embodiment of an inline flow twister with helical baffle plates according to the present disclosure.

FIG. 4 is a schematic diagram of an embodiment of an inline flow mixer without helical baffle plates according to the present disclosure.

FIG. 5 is a schematic diagram of an embodiment of an inline flow twister with twister plates inside an inner tube of the mixer according to the present disclosure.

FIG. 6 is a schematic diagram of an embodiment of an inline flow twister with twister plates inside the inner tube of the mixer and baffle plates according to the present disclosure.

FIGS. 7A-7C are schematic diagrams of installation location and orientations of the inline flow twister according to the present disclosure.

FIGS. 8-10 are computational fluid dynamics simulations of flow through embodiments of a mixer according to the present disclosure.

### DETAILED DESCRIPTION

The present disclosure will proceed to describe certain non-limiting examples of the technology that may be particularly advantageous for petrochemical processing and refining, such as at least with respect to the production of ethylene and/or propylene using a steam cracking heater. However, it will be appreciated that the concepts of the disclosure can be applied to a broad range of technologies and industries. In particular, the concepts of the disclosure can be applied equally to any industry or technology utilizing a fired or heating process that involves mixing of two streams and in particular, for two phases of flow in order to fully vaporize the flows after the mixing. Such concepts can be installed in new heaters, or existing heaters can be retrofitted with the technology to improve the heater performance and reduce heater downtime for maintenance.

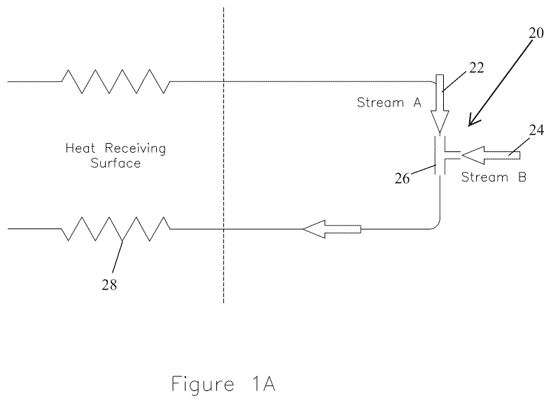

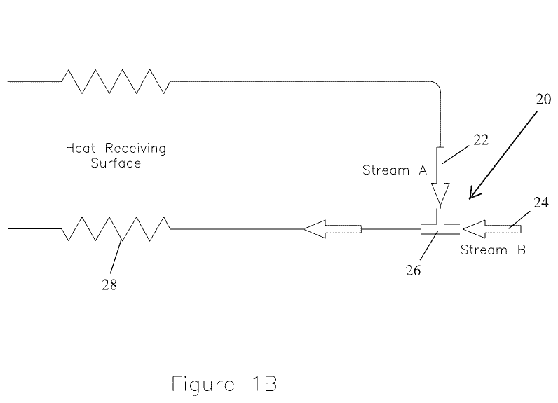

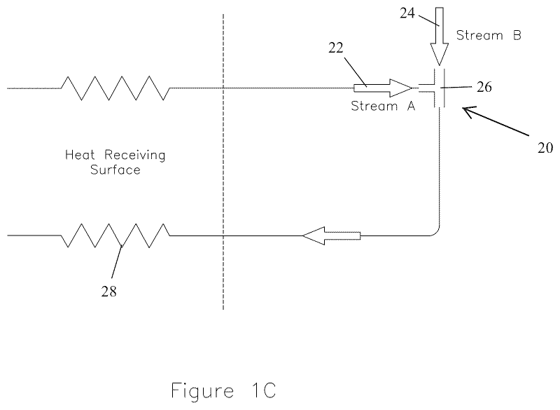

FIGS. 1A-1C are schematic diagrams of a known static mixer 20 to provide additional context regarding the benefits and advantages of the concepts of the disclosure. In a known static mixer 20, a hydrocarbon stream 22 (Stream A) and a dilution stream 24 (Stream B) are mixed through direct pipe connections. FIGS. 1A-1C provide variations of the mixing location and mixer orientation. The combined mixture is then provided along pipes 26 to a heat receiving surface 28 to heat the mixture for further downstream processing. When the hydrocarbon stream 22 contains heavy components or impurities, the liquid droplets, particularly from the hydrocarbon stream 22, may wet the internal surface of the pipes 26 and accumulate. As the liquid moves to the heat receiving surface 28, the combination of the incident heat and the liquid in the pipes 26 leads to fouling that eventually restricts the flow through the pipes 26 and the heat receiving surface 28 (which may also be pipes 28). As used herein, “fouling” may refer to insoluble materials or precipitates that build up on mechanical components and includes, but is not limited to, scaling, corrosion, sludge, and debris, as well as evaporation of higher molecular weight components of a hydrocarbon feedstock at a heated surface which forms deposits that will gradually build up and harden over time leading to high pressure drop and poor heat transfer in the heat receiving sections. In response, the mixer 20 and overall system may need to be shut down for cleaning and maintenance, or the heater throughput may be reduced due to the reduction in fluid flow.

Known mixers, such as mixer 20, perform mixing at the flow spoiler or create mixing that does not prevent the liquid droplets from contacting downstream mechanical surfaces. As a result, operation of known mixers is highly likely to lead to fouling of the mechanical components and the disadvantages associated with the same.

In contrast, the concepts of the disclosure keep the two streams separated to prevent or minimize droplet vaporization before the flow pattern is fully developed. Once the flow pattern is developed, the two stream are mixed, but the stream with liquid droplets is kept away from mechanical surfaces, or contact with mechanical surfaces is delayed, if any, to minimize potential fouling.

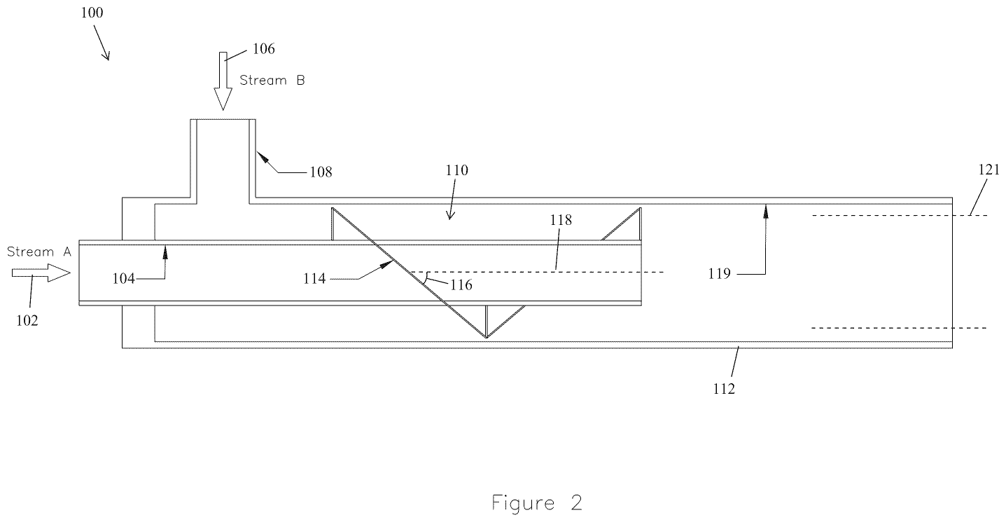

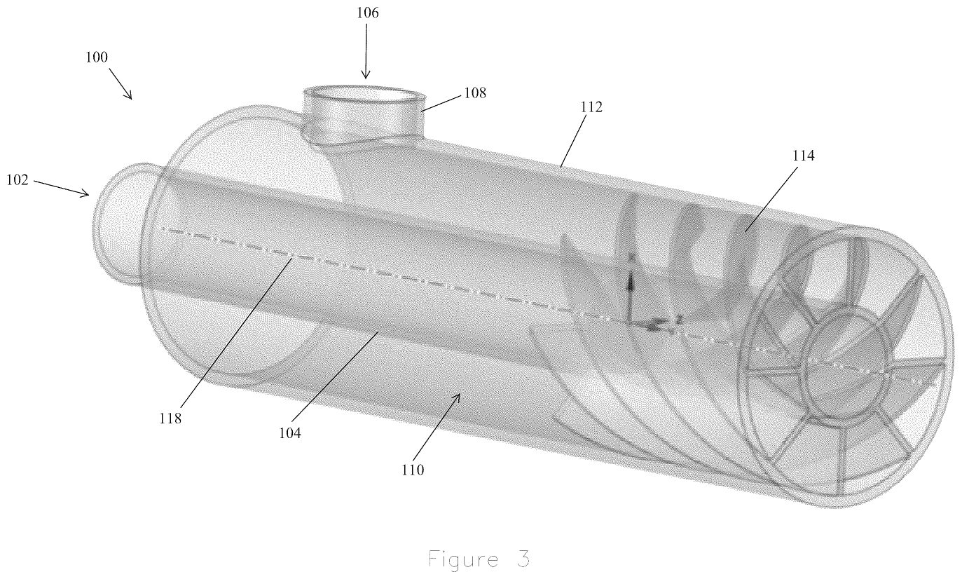

FIG. 2 and FIG. 3 are schematic diagrams of one or more embodiments of an inline flow twister 100 (which may also be referred to herein as an inline mixer 100 or a mixer 100) according to the present disclosure. A hydrocarbon stream 102 (Stream A), which may contain liquid droplets, flows through inner tube or tubes 104. A diluent stream 106 (Stream B) flows through a nozzle 108 and through a space 110 between the inner tube 104 and an outer tube 112. In an embodiment, the diluent stream is a gaseous stream, such as, for example, steam, that leads to vaporization of the hydrocarbon stream 102 after mixing, as described further herein. The diluent stream 106 flows through and around a number of helical baffle plates 114. In some embodiments, the mixer 100 includes 3 or more baffle plates 114, or more preferably, includes between 6 to 8 baffle plates 114. Of course, the mixer 100 may also include a selected number of baffle plates 114 that is more or less than the non-limiting examples above.

The baffle plates 114 may be arranged around, and coupled to, the inner tube 104 and extend around the inner tube 104 in complete and continuous helical revolutions along at least a portion of a length of the inner tube 104. In an embodiment, the baffle plates 114 extend along less than half, half, or more than half and up to an entirety of the length of the inner tube 104. Further, the baffle plates 114 may have a selected height relative to the inner tube 104 and the outer tube 112 (i.e., the baffle plates 114 extend from the inner tube 104 through a selected amount of the space 110 between the inner tube 104 and the outer tube 112). In some embodiments, the baffle plates 114 extend longitudinally (i.e., in a vertical direction in the orientation of FIG. 2) less than half, half, more than half, or through an any entirety of the space 110, in which case, the baffle plates 114 are in contact with inner tube 104, and in contact with or very close to the outer tube 112. In an embodiment, the baffle plates 114 are welded only to the inner tube 104 with a manufacturing or fabrication tolerance between the outer peripheral edges of the baffle plates 114 and the interior surface of the outer tube 112. Further, the baffle plates 114 may be located at one terminal end of the inner tube 104 closest to a mixing interface between the streams 102, 106, as best shown in FIG. 3. The baffle plates 114 may be at an angle 116 to a flow axis 118 defined by the hydrocarbon stream 102 (i.e., a horizontal axis through a center of the inner tube in the orientation of FIG. 2) that is preferably between 30 and 45 degrees including all intervening values to at least two decimal places, and including limit values. In some embodiments, the angle 116 is less than 30 degrees or greater than 45 degrees. Further, each baffle plate 114 may have a selected spacing relative to the other baffle plates 114 that may be as low as 6 inches to 1 foot or may be more than one foot, such as at least 3 feet, 4 feet, 5 feet, or more. The angular alignment of the helical baffle plates 114 relative to the tubes 104, 112 and the spacing between the plates 114 enable a twisted flow of the diluent stream 106 along the space 110 during operation.

In an embodiment, the length of the inner tube 104 is less than the length of the outer tube 112 such that the inner tube 104 terminates (i.e., has an outlet) inside the outer tube 112. The diluent stream 106 flows through the space 110 and through the baffle develops 114 to develop a twisted flow. After the twisted flow is fully developed, the two streams 102, 106 mix at the outlet of the inner tube 104. The twisted flow of the diluent stream 106 that is created by the baffles 114 travels along an interior surface 119 of the outer tube 112 and forms a boundary layer along the internal surface of the outer tube 112 that is represented in FIG. 2 by dashed lines 121. The boundary layer 121 prevents or minimizes liquid and/or liquid droplets in the hydrocarbon stream 102 that exit the inner tube 104 from contacting the internal surface 119 and fouling the internal surface 119. Further, the liquid and/or liquid droplets that reach the boundary layer 121 are likely to be vaporized by the twisted flow of the diluent 106, which may be heated before being provided to the outer tube 112. Because the tubes 104, 112 are arranged coaxially and the hydrocarbon stream 102 traverses the inner tube 102 without substantial changes in direction, there is minimal pressure drop in the mixer 100. Further, the twisting flow produced by the baffles 114 also advantageously mixes the streams 102, 106.

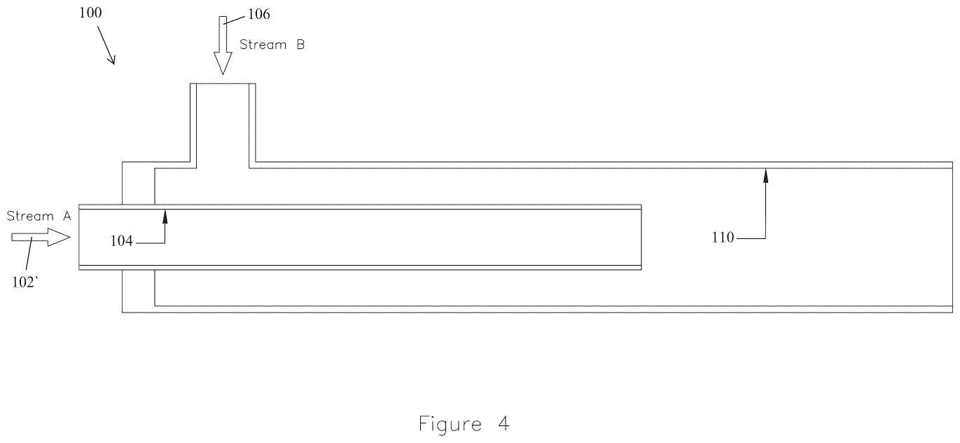

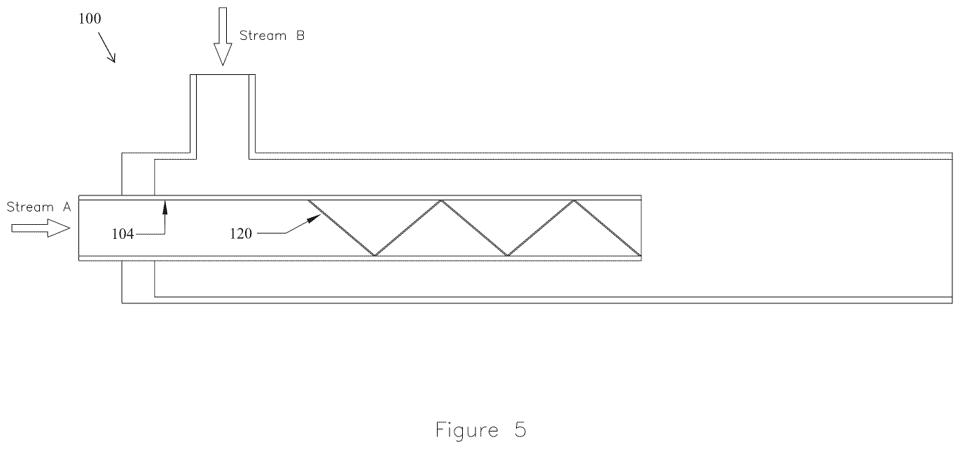

As shown in FIG. 4, the mixer 100 may include only two coaxial tubes, namely inner tube 104 and outer tube 112, without the baffle plates 114 in some embodiments. As shown in FIG. 5, the mixer 100 may include, instead of baffle plates 114, only twister plates 120 (which may also be referred to herein as twisting baffle plates 120) inside the inner tube 104. In an embodiment, the twister plates 120 may have some or all of the same characteristics described above for the baffle plates 114 with the difference being their location in the mixer 100.

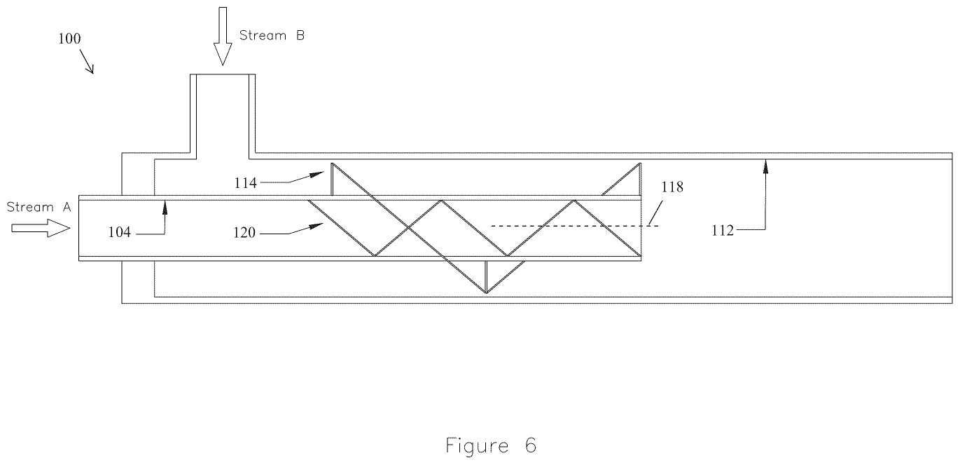

In an embodiment, the mixer 100 includes both twister plates 120 inside the inner tube 104, as well as the helical baffle plates 114, as shown in FIG. 6. The helical baffle plates 114 and the twisting baffle plates 120 may have the same or different angles relative to the flow axis 118, and may create rotating or twisted flows in the same or opposite directions in the inner and outer coaxial tubes 104, 112.

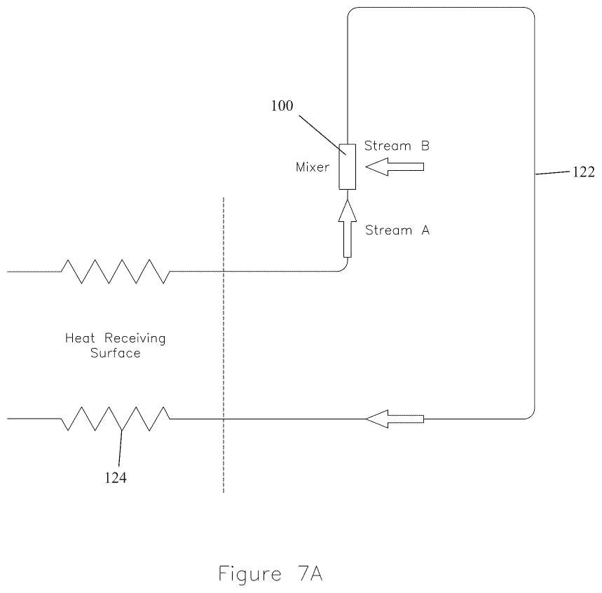

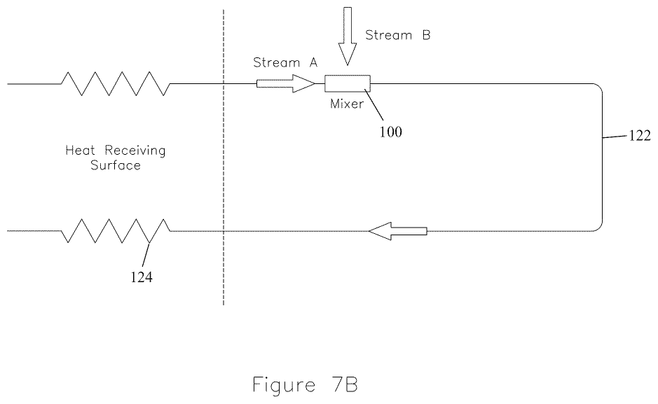

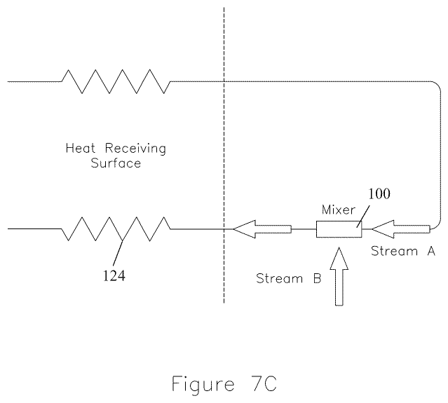

The mixer 100 can be installed in various locations and orientations depending on design factors and available mechanical space. For example, in FIG. 7A, the mixer 100 is installed and aligned vertically according to the ordinary meaning of “vertical” (i.e., gravity pulls object down along a vertical path) to have upward flow after mixing to help suspend liquid droplets during vaporization. In an embodiment, piping 122 from the mixer 100 to a heat receiving surface 124 may have a straight length of 10 to 15 times an interior diameter of the piping 122 prior to any flow disturbance and a total linear length 20 to 30 times the interior diameter of the piping to allow space for vaporization to be completed before entering the heat receiving surface section 124. The arrangement of FIG. 7A may provide more time for process streams that contain very heavy components to be fully vaporized before reaching the heat receiving surface 124 to avoid fouling.

The mixer 100 can also be installed as shown in FIG. 7B to have a horizontal arrangement. In an embodiment, it is preferable to have similar straight and total linear tube length after the mixing. Such an arrangement may allow a process stream with moderately heavy components to become fully vaporized before entering the heat receiving surface 124.

Where mechanical space may be limited, the mixer 100 can be installed as shown in FIG. 7C. More specifically, the mixer 100 can be installed directly in front of the straight heat receiving tubes leading into the heat receiving surface 124. In such an embodiment, it is preferred to have a greater angle 116 of the of the baffle plates 114 relative to the flow axis 118 (FIG. 2) to provide a more intensive twisting flow path. The more intensive flow path increases the heat transfer coefficient and allows the diluent stream 106 to reach higher temperature while mixing with the hydrocarbon stream 102 (FIG. 2). The greater angle will also promote stronger mixing between the streams 102, 106. The higher temperature of the diluent stream 106 and stronger mixing will help vaporize liquid droplets more quickly and minimize the risk of fouling at the heating surface 124.

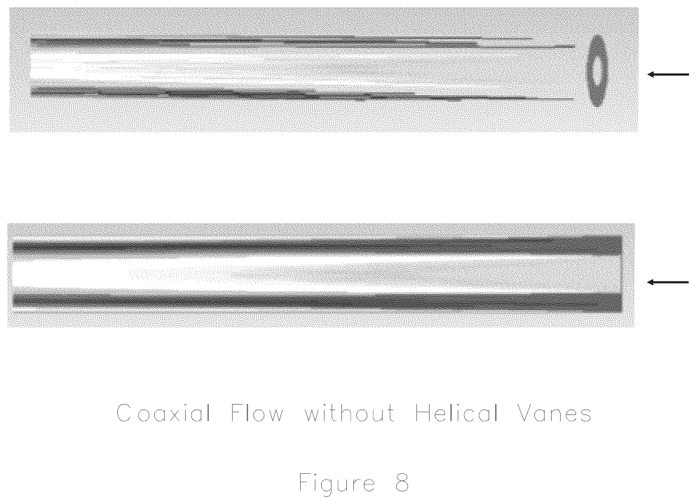

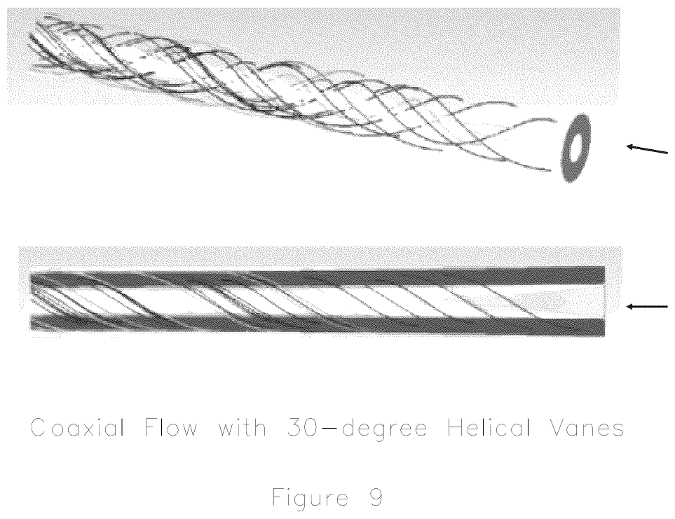

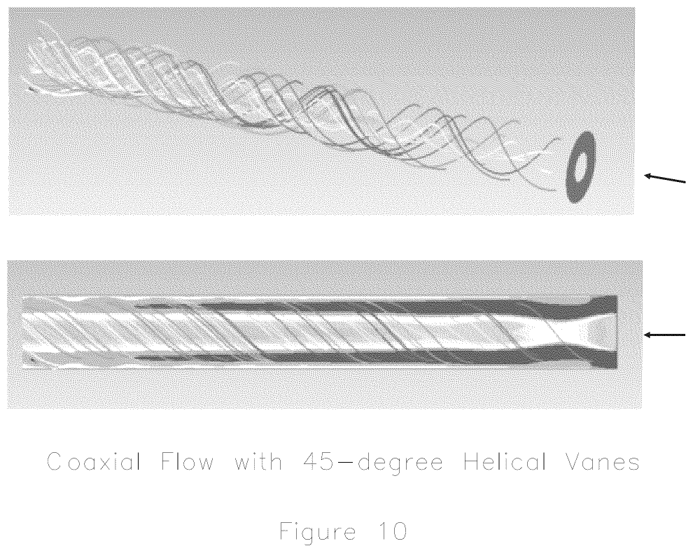

FIGS. 8-10 are outputs from computational fluid dynamics (CFD) simulations showing flow trajectories obtained utilizing embodiments of the mixers 100 described herein. The simulations confirm that the tube designs of the mixers 100 effectively prevent or minimize the central stream in the inner tube 104 from reaching the internal surface of the outer tube 112 (FIG. 2) to prevent or minimize fouling. In particular, embodiments including twisting flows (whether via helical baffle plates 114, twisting plates 120, or both), promotes faster mixing while further improving separation of the central stream from the internal surface of the outer tube 112 (FIG. 2). In FIGS. 8-10, the boundary layer that is high in diluent and low in hydrocarbon is represented by the outer dark lines with the hydrocarbon stream being the internal lighter lines.

In view of the above, the mixers 100 described herein have a number of benefits and advantages. For example, the mixer 100 may keep two streams separate and may form a flow pattern that keeps the liquid droplets in suspension and enables full vaporization before the droplets contact a solid surface. Further, the two streams may intentionally not be fully mixed prior to exiting the mixing device, and instead the high temperature of the convection section wall is exploited to create a boundary layer of diluent that is rapidly heated to a high temperature. Such an arrangement essentially exploits the Leidenfrost effect since the diluent is heated to a high temperature at the tube inner wall and vaporization of droplets within the mixed fluid stream is strongly favored over vaporization of droplets at the tube wall.

Further, the distribution of concentration and temperature may not be constant in the mixer, in order to favor vaporization of droplets in the main flow as opposed to at the heated surface downstream of the mixing device. In some embodiments, the two streams may only be mixed at the exit of the device once the flow is fully formed to improve vaporization.

In some embodiments, the mixers of the present disclosure mix two streams: one gaseous and the other containing liquid or liquid droplets. At the mixing point, the liquid or liquid droplets may get vaporized. During the vaporization process, any heavy components in the liquid may foul the mechanical surface, such as the internal surface of the carrying tube, vessel or the mixer components. The mixers of the disclosure include two co-axial pipes that keep the two streams separate before mixing. The non-fouling stream flows in the outer pipe and the fouling-possible stream flows in the inner pipe. Between the inner and outer pipes, the mixer may include helical baffles that will create twisted flows in the non-fouling stream before exiting the co-axial pipe section. The twisted flow will form a boundary layer that may prevent or minimize the stream with liquid and/or liquid droplets from contacting the piping surface. The liquid droplets will gradually mix with the stream near the tube surface and become vaporized to minimize the possibility of liquid contacting with the tube surface that may lead to fouling.

In an embodiment, a mixer includes: an outer tube; a nozzle in communication with the outer tube; an inner tube inside the outer tube and having an inlet, the inner tube operable to receive a hydrocarbon stream through the inlet and convey the hydrocarbon stream along a flow path through the inner tube from the inlet to an outlet of the inner tube; a space between the inner tube and the outer tube, the outer tube operable to receive a diluent stream via the nozzle and convey the diluent stream through the space; and at least one baffle coupled to the inner tube and extending from the inner tube toward the outer tube through at least a portion of the space, the at least one baffle operable to generate a twisted diluent flow from the diluent stream, wherein the twisted diluent flow and the hydrocarbon stream are mixed downstream of the outlet of the inner tube with the twisted diluent flow forming a boundary layer along an internal surface of the outer tube.

In an embodiment, the inner tube is arranged coaxially with respect to the outer tube, the inner tube having a length that is less than a length of the outer tube, the boundary layer operable to prevent or minimize liquid in the hydrocarbon stream from contacting an internal surface of the outer tube.

In an embodiment, the at least one baffle is a plurality of helical baffles extending around the inner tube, the plurality of helical baffles having an angle relative a flow axis through the inner tube between and including 30 degrees and 45 degrees.

In an embodiment, the inner tube includes at least one twister plate operable to generate a twisted hydrocarbon flow from the hydrocarbon stream.

In an embodiment, the at least one baffle is a helical baffle on an exterior surface of the inner tube.

In an embodiment, the boundary layer is operable to prevent or minimize liquid in the hydrocarbon stream from contacting an internal surface of the outer tube.

In an embodiment, a mixer includes: an outer tube; an inner tube inside the outer tube and arranged coaxially with respect to the outer tube, the inner tube having an inlet and being operable to receive a hydrocarbon stream through the inlet and convey the hydrocarbon stream along a flow path through the inner tube from the inlet to an outlet of the inner tube positioned inside the outer tube; and a space between the inner tube and the outer tube, the outer tube operable to receive a diluent stream and convey the diluent stream through the space, wherein the diluent stream and the hydrocarbon stream are mixed downstream of the outlet of the inner tube with the diluent stream forming a boundary layer along an internal surface of the outer tube to prevent or minimize liquid or liquid droplets from the hydrocarbon stream from contacting the internal surface of the outer tube.

In an embodiment, the mixer further includes at least one baffle coupled to the inner tube and extending from the inner tube toward the outer tube through at least a portion of the space, the at least one baffle operable to generate a twisted diluent flow from the diluent stream, wherein the twisted diluent flow forms the boundary layer.

In an embodiment, the at least one baffle is a plurality of helical baffles extending around the inner tube, the plurality of helical baffles having an angle relative a flow axis through the inner tube between and including 30 degrees and 45 degrees.

In an embodiment, the inner tube includes at least one twister plate operable to generate a twisted hydrocarbon flow from the hydrocarbon stream.

In an embodiment, a direction of rotation of the twisted diluent flow is the same as a direction of rotation of the twisted hydrocarbon flow.

In an embodiment, a direction of rotation of the twisted diluent flow is opposite a direction of rotation of the twisted hydrocarbon flow.

In an embodiment, the inner tube includes at least one twister plate operable to generate a twisted hydrocarbon flow from the hydrocarbon stream.

In an embodiment, a mixer includes: an outer tube; an inner tube arranged within the outer tube, the inner tube being operable to receive a hydrocarbon stream and convey the hydrocarbon stream through the inner tube; and a space between the inner tube and the outer tube, the outer tube operable to receive a diluent stream and convey the diluent stream through the space, wherein the diluent stream and the hydrocarbon stream are mixed downstream of the outlet of the inner tube with the diluent stream configured to produce a boundary layer along an internal surface of the outer tube to prevent or minimize liquid or liquid droplets from the hydrocarbon stream from contacting the internal surface of the outer tube.

In an embodiment, the inner tube includes at least one baffle on an outer surface of the inner tube, the at least one baffle operable to generate a twisted diluent flow from the diluent stream that produces the boundary layer.

In an embodiment, the at least one baffle is arranged on the outer surface of the inner tube at an angle relative to a flow axis through the inner tube between and including 30 degrees and 45 degrees.

In an embodiment, the inner tube includes at least one twister plate.

In an embodiment, the inner tube includes at least one twister plate internal to the inner tube operable to produce a twisted hydrocarbon flow and at least one baffle external to the inner tube operable to produce a twisted diluent flow that produces the boundary layer.

In an embodiment, the inner tube is arranged coaxially with respect to the outer tube.

In an embodiment, a portion of a length of the inner tube is received within the outer tube, and the inner tube further includes a flow control device being at least one baffle or at least one twister plate, the flow control device extending along less than an entirety of the portion of the length of the inner tube.

In the above description, certain specific details are set forth in order to provide a thorough understanding of various embodiments of the disclosure. However, one skilled in the art will understand that the disclosure may be practiced without these specific details. In other instances, well-known structures associated with the technology have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

Unless the context clearly dictates otherwise, relative terms such as “approximately,” “substantially,” and other derivatives, are construed to include an ordinary error range or manufacturing tolerance due to slight differences and variations in manufacturing and, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise. All ranges of dimensions or other values include all possible intervening and limit values, unless the context clearly dictates otherwise.

The present application claims priority to U.S. Provisional Application No. 63/351,755, filed Jun. 13, 2022 in the United States Patent and Trademark Office, the entire contents of which are incorporated herein by reference.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the breadth and scope of a disclosed embodiment should not be limited by any of the above-described embodiments, but should be defined only in accordance with the following claims and their equivalents.

1. A mixer, including:
an outer tube;
a nozzle in communication with the outer tube;
an inner tube inside the outer tube and having an inlet, the inner tube operable to receive a hydrocarbon stream through the inlet and convey the hydrocarbon stream along a flow path through the inner tube from the inlet to an outlet of the inner tube;
a space between the inner tube and the outer tube, the outer tube operable to receive a diluent stream via the nozzle and convey the diluent stream through the space; and
at least one baffle coupled to the inner tube and extending from the inner tube toward the outer tube through at least a portion of the space, the at least one baffle operable to generate a twisted diluent flow from the diluent stream,
wherein the twisted diluent flow and the hydrocarbon stream are configured to be mixed downstream of the outlet of the inner tube with the twisted diluent flow forming a boundary layer along an internal surface of the outer tube.

2. The mixer of claim 1, wherein the inner tube is arranged coaxially with respect to the outer tube, the inner tube having a length that is less than a length of the outer tube, the boundary layer operable to prevent or minimize liquid in the hydrocarbon stream from contacting an internal surface of the outer tube.

3. The mixer of claim 1, wherein the at least one baffle is a plurality of helical baffles extending around the inner tube, the plurality of helical baffles having an angle relative a flow axis through the inner tube between and including 30 degrees and 45 degrees.

4. The mixer of claim 1, wherein the inner tube includes at least one twister plate operable to generate a twisted hydrocarbon flow from the hydrocarbon stream.

5. The mixer of claim 1, wherein the at least one baffle is a helical baffle on an exterior surface of the inner tube.

6. The mixer of claim 1, wherein the boundary layer is operable to prevent or minimize liquid in the hydrocarbon stream from contacting an internal surface of the outer tube.

7. A mixer, including:
an outer tube;
an inner tube inside the outer tube and arranged coaxially with respect to the outer tube, the inner tube having an inlet and being operable to receive a hydrocarbon stream through the inlet and convey the hydrocarbon stream along a flow path through the inner tube from the inlet to an outlet of the inner tube, the outlet of the inner tube positioned inside the outer tube; and
a space between the inner tube and the outer tube, the outer tube operable to receive a diluent stream and convey the diluent stream through the space,
wherein the diluent stream and the hydrocarbon stream are mixed downstream of the outlet of the inner tube with the diluent stream forming a boundary layer along an internal surface of the outer tube to prevent liquid or liquid droplets from the hydrocarbon stream from contacting the internal surface of the outer tube.

8. The mixer of claim 7, further comprising:
at least one baffle coupled to the inner tube and extending from the inner tube toward the outer tube through at least a portion of the space, the at least one baffle operable to generate a twisted diluent flow from the diluent stream,
wherein the twisted diluent flow forms the boundary layer.

9. The mixer of claim 8, wherein the at least one baffle is a plurality of helical baffles extending around the inner tube, the plurality of helical baffles having an angle relative a flow axis through the inner tube between and including 30 degrees and 45 degrees.

10. The mixer of claim 8, wherein the inner tube includes at least one twister plate operable to generate a twisted hydrocarbon flow from the hydrocarbon stream.

11. The mixer of claim 10, wherein a direction of rotation of the twisted diluent flow is the same as a direction of rotation of the twisted hydrocarbon flow.

12. The mixer of claim 10, wherein a direction of rotation of the twisted diluent flow is opposite a direction of rotation of the twisted hydrocarbon flow.

13. The mixer of claim 7, wherein the inner tube includes at least one twister plate operable to generate a twisted hydrocarbon flow from the hydrocarbon stream.

14. A mixer, comprising:
an outer tube;
an inner tube arranged within the outer tube, the inner tube being operable to receive a hydrocarbon stream and convey the hydrocarbon stream through the inner tube; and
a space between the inner tube and the outer tube, the outer tube operable to receive a diluent stream and convey the diluent stream through the space,
wherein the diluent stream and the hydrocarbon stream are mixed downstream of the outlet of the inner tube with the diluent stream configured to produce a boundary layer along an internal surface of the outer tube to prevent or minimize liquid or liquid droplets from the hydrocarbon stream from contacting the internal surface of the outer tube.

15. The mixer of claim 14, wherein the inner tube includes at least one baffle on an outer surface of the inner tube, the at least one baffle operable to generate a twisted diluent flow from the diluent stream that produces the boundary layer.

16. The mixer of claim 15, wherein the at least one baffle is arranged on the outer surface of the inner tube at an angle relative to a flow axis through the inner tube between and including 30 degrees and 45 degrees.

17. The mixer of claim 14, wherein the inner tube includes at least one twister plate.

18. The mixer of claim 14, wherein the inner tube includes at least one twister plate internal to the inner tube operable to produce a twisted hydrocarbon flow and at least one baffle external to the inner tube operable to produce a twisted diluent flow that produces the boundary layer.

19. The mixer of claim 14, wherein the inner tube is arranged coaxially with respect to the outer tube.

20. The mixer of claim 14, wherein a portion of a length of the inner tube is received within the outer tube, and the inner tube further includes a flow control device being at least one baffle or at least one twister plate, the flow control device extending along less than an entirety of the portion of the length of the inner tube.
